(19) United States
(12) Patent Application Publication
(10) Pub. No.: US 2006/0231336 A1
(43) Pub. Date: Oct. 19, 2006

(54) Pressure compensated lube oil system

(76) Inventor: Delbert Wesley Crawford, San Jose, CA (US)

Correspondence Address: Donald E. Schreiber;A Professional Corporation, Post Office Box 2926, Kings Beach, CA, 96143-2926, US

(21) Appl. No.: 11/393,521

(22) Filed: Mar. 29, 2006

Related U.S. Application Data
(60) Provisional application No. 60/665,807, filed on Mar. 29, 2005.
(60) Provisional application No. 60/667,612, filed on Apr. 4, 2005.

(51) Int. Cl. F16C 1/24

(52) U.S. Cl. 184/5.1

(57) ABSTRACT

A lube oil system that opposes infusion of water into a submerged bearing assembly sealed within a lubricant cavity. The system includes a conduit that extends from within to outside the lubricant cavity. Tubing connects a lube oil reservoir to the conduit's end located outside the cavity. The reservoir and the tubing supply lube oil to the cavity. A passage connects a pressure inducing bell having an open lower end to the reservoir. The open end of the bell is located no higher than the lubricant cavity. Upon immersion of the open end in water, via the passage the system couples the water's hydraulic pressure from the bell to a column of air trapped atop the reservoir. The pressure of the air in the reservoir together with the pressure of lube oil in the reservoir is then coupled to the lubricant cavity via the tubing and the conduit.

### CLAIM OF PROVISIONAL APPLICATION RIGHTS

This patent application claims the benefit of U.S. Provisional Patent Application Nos. 60/665,807 filed Mar. 29, 2005, and 60/667,612 filed Apr. 4, 2005.

### BACKGROUND

1. Technical Field

A pressure compensated oil lubrication system adapted for preventing water from entering a bearing assembly if the bearing assembly becomes submerged in water, the lubrication system being particularly adapted for protecting bearings included in wheel spindle and hub assemblies of boat and/or snowmobile trailers.

2. Background Art

There exist a number of different systems which endeavor to prevent water from entering a boat trailer's wheel bearings when its wheel spindle and hub assembly becomes submerged in water. Usually, a single, initial unprotected immersion of a boat trailer's wheel bearings in water is inconsequential. Conversely, repeated immersions in water, particularly salt water, combined with water's corrosive action, especially when hub assemblies become heated during normal course of towing, and/or high ambient temperatures prior to submersion in water. Over time frequent launchings produce catastrophic wheel bearing failure. In many instances a catastrophic wheel bearing failure only extends travel time, incurs perhaps a several hundred dollar expense for having the trailer towed, and approximately $650.00 to $700.00 cost for repairing the boat trailer's wheel bearing, seal and spindle. However, on other occasions, catastrophic boat trailer wheel bearing failures have caused injury, forest fires and even death.

There exist two general classes of wheel spindle and hub assemblies for trailers that respectively use either grease or oil as a bearing lubricant. Wheel spindle and hub assemblies normally include a spindle, two or more rolling elements that support a hub, the hub itself, and seals to the spindle that respectively close opposite ends of the hub. A cavity surrounding the spindle established by the hub and the inner seal and outer seal, i.e. dust cap, holds either grease or oil lubricant. When such a wheel spindle and hub assembled at normal atmospheric pressure becomes immersed in water, the water's greater hydraulic pressure tends to infuse water into the lubricant cavity.

For oil-bath wheel bearings, the lubricant cavity is filled with oil to a level sufficient to lubricate the bearings. When operating, a sufficient quantity of oil must remain in this cavity at all times. Consequently, preventing oil loss is an important concern for oil-bath wheel spindle and hub assemblies. It is essential that the lubricant cavity remain sealed at all times. Accordingly, seals of an oil-bath wheel spindle and hub assembly must prevent oil leakage from the wheel bearing, while also barring entry of water and contaminants into the wheel bearing.

Towing a boat trailer any significant distance heats the wheel spindle and hub assembly. Expansion of hot air in the lubricant cavity increases the internal pressure which may cause hot air and/or lubricant to escape from the hub through the seals. When a boat trailer is then backed into cold water, the wheel spindle and hub assembly cools rapidly which reduces the air pressure inside the lubricant cavity both for grease and oil filled hubs. Reduced air pressure inside the lubricant cavity tends to draw water and contaminants through the seals into the cavity. Any water or contaminant entering the lubricant cavity shortens the wheel spindle and hub assembly's life span due to internal rust and abrasion.

Efforts have been made to eliminate problems associated with immersing a hot wheel bearing assembly in cold water by using pressurized inflatable seals, pressurized lubricant cavities and venting tubes. U.S. Pat. No. 3,330,563 discloses a wheel bearing assembly which includes an inflatable seal preferably pressurized by air from drawn from a tank. U.S. Pat. No. 3,226,162 discloses pressurizing the lubricant cavity containing trailer wheel bearings with air drawn from the trailer's tires. U.S. Pat. No. 4,489,988 discloses a sealed wheel bearing assembly that is pressurized by air supplied by an air compressor.

As air is drawn from a tank pressure decreases thereby decreasing the effectiveness of an inflatable seal system. Pressurized air tanks must be periodically recharged or replaced because an unpressurized tank renders the inflatable seal system inoperable. Furthermore, pressurization must be manually turned on and off or the inflatable wheel bearing seal will fail. Proper operation of wheel spindle and hub assemblies or inflatable seals supplied with pressurized air from an air compressor also requires periodic maintenance. In many instances, casual operators lack sufficient knowledge to properly maintain these systems. Thus, periodic maintenance will likely increase the system's cost if its owner must pay someone else for its maintenance. Therefore, pressurized wheel spindle and hub assemblies or inflatable seals increase both initial and maintenance costs for operating a boat trailer.

Alternative systems disclosed respectively in U.S. Pat. Nos. 3,077,948 and 4,190,133 employ a spring driven piston that pressurizes grease within a trailer's wheel spindle and hub assembly. A cap for the hub of these systems includes a fitting that permits filling the hub with grease. The cap disclosed in U.S. Pat. No. 4,190,133 includes an aperture that releases excess grease from the hub. Like other types of aperture's that unsafely extend the wheel spindle and hub assembly, this type of dust cap suffer from damage and loss due to collisions in parking lots and launch ramps. Wheel spindle and hub assemblies having this type of aperture also suffer from over-greasing which causes seal blowouts.

Another system disclosed in U.S. Pat. No. 4,262,978, also uses a cap for the hub having a grease fitting, and its spindle includes a conduit from the lubricant cavity which permits excess grease to vent from the cavity. Reportedly, the conduit allows the grease to push any air trapped in the lubricant cavity through the conduit to the atmosphere. Over time grease must be regularly added since it will continually move through the assembly out the conduit to the atmosphere. Grease in the conduit apparently creates a dam at the end thus closing the lubricant cavity to the atmosphere. The grease dam, if maintained, reportedly prevents water and contamination from entering the bearing when the wheel spindle and hub assembly are submerged in water. Furthermore, if the lubricant cavity is totally filled with grease, reportedly there is little or no pressure change when a hot wheel spindle and hub assembly is immersed in cold water. In actual operation, filling a wheel spindle and hub assembly fully with grease causes very high friction so it overheats quickly even at moderate speeds. The high friction and overheating results from the bearings rolling elements constantly pushing grease from their path of travel. The resultant heat and pressure causes excess lubricant, i.e. grease, to vent through any available path such as a vent tube, or to compromise the barrier provided by the inner and outer seals. It appears doubtful that a totally filled lubricant cavity could be maintained in actual operation. Moreover, hot grease in the conduit tends to drip from the wheel spindle and hub assembly thereby requiring continued maintenance to preserve the water seal. Wheel spindle and hub assemblies are subject to repeated thermal shocks which produces a vacuum in their lubricant cavities upon submersion. The vacuum created in this way causes water to accumulate inside the wheel spindle and hub assemblies. Because grease is more viscous than oil, bearing pre-load adjustment must be lower for grease than for oil. Reportedly, lack of bearing pre-load leads to shortened bearing and seal life.

Another system disclosed in U.S. Pat. No. 4,557,526 uses an oil-filled axle tube which extends between both wheel bearings respectively located at opposite ends thereof. This system also includes a venting tube coupled to the oil-filled axle tube. Proper functioning of this system requires that the venting tube extend upwardly to a height greater than the depth of the water in which a trailer becomes submerged. Consequently, the trailer's owner or manufacturer must anticipate the maximum depth to which the trailer will ever be submerged which usually mandates using a very long and, therefore, easily damaged venting tube. Any hole in this system permits water to enter the oil-filled axle tube because both air and oil displaced by the water flow easily through the venting tube. The disclosed system does not compensate for the difference between water pressure present at the wheel spindle and hub assembly and atmospheric pressure above the water. In addition, this system is more expensive to manufacture than conventional trailer axle assemblies.

An oil-bath wheel spindle and hub assembly disclosed in U.S. Pat. No. 6,447,072 includes a heat dissipating oil seal cap with a transparent window for observing the lubricant level. Thermally conductive vanes on the oil seal cap provide a heat sink for transferring heat away from the wheel spindle and hub assembly to ambient atmosphere. Like other systems, this system can be damaged in parking lots, by curbs, and by launch ramps. The system is also subject to thermal shocks which upon submersion produces a vacuum in lubricant cavities. For example, desert ambient temperature can exceed 100° F. when launching a boat into 50° F. water.

U.S. Pat. No. 5,098,168 discloses an oil-bath wheel spindle and hub assembly that prevents internal pressure build-up by a comparatively short conduit that at one end opens near the bottom of the lubricant cavity and at its other end is open to the atmosphere. The conduit's open end is located at an upper end of an air chamber included in the spindle that hangs down below the spindle and hub assembly. The lower end of the chamber is open to the atmosphere to trap air therein as the hub and spindle assembly becomes submerged. Upon immersion, air in the chamber becomes compressed which, via the conduit, pressurizes the lubricating chamber to prevent water and contaminants from entering into the wheel spindle and hub assemblies. Heating of air within the lubricant cavity tends to force oil from the wheel spindle and hub assemblies through the conduit. Subsequent cooling of air within the lubricant cavity tends to draw water and/or additional air into the wheel spindle and hub assembly through the conduit. Reportedly, checking once a year to “top off” the oil in the disclosed wheel spindle and hub assemblies prevents entry of water and contaminants into the wheel bearing.

### BRIEF SUMMARY

An object of this disclosure is to provide an improved lube oil system that prevents water from entering sealed bearing assemblies when they are surrounded by water.

Another object of this disclosure is to provide an improved lube oil system that prevents lubricant leakage from sealed bearing assemblies due to excessively high pressure within the bearing.

Another object of this disclosure is to provide an improved lube oil system for sealed bearing assemblies which become immersed in water that requires no maintenance.

Another object of this disclosure is to provide an improved lube oil system for sealed bearing assemblies which become immersed in water that requires no moving parts.

Another object of this disclosure is to provide an improved lube oil system for sealed bearing assemblies which become immersed in water which extends bearing life.

Another object of this disclosure is to provide an improved lube oil system for sealed bearing assemblies which become immersed in water which prevents catastrophic bearing failure.

Another object of this disclosure is to provide an improved lube oil system for sealed bearing assemblies which become immersed in water which is more rugged.

Another object of this disclosure is to provide an improved lube oil system for sealed bearing assemblies which become immersed in water which has no moving parts.

Another object of this disclosure is to provide an improved lube oil system for sealed bearing assemblies which become immersed in water that is easily retrofitted to existing bearings.

Another object of this disclosure is to provide an improved lube oil system for sealed bearing assemblies which become immersed in water which is simple.

Another object of this disclosure is to provide an improved lube oil system for sealed bearing assemblies which is compatible with existing wheel-spindle and hub assemblies, existing wheel rims and tires, and existing wheel covers.

Another object of this disclosure is to provide an improved lube oil system for sealed bearing assemblies which is less polluting.

Another object of this disclosure is to provide an improved lube oil system for sealed bearing assemblies that increases highway safety.

Another object of this disclosure is to provide an improved lube oil system for sealed bearing assemblies which is less expensive to operate.

Another object of this disclosure is to provide an improved lube oil system for sealed bearing assemblies which become immersed in water that is economical to manufacture.

Briefly, a lube oil system in accordance with the present disclosure is adapted for use with a sealed bearing assembly that is conjoined with a lubricant cavity. The disclosed lube oil system includes a conduit having an open first end located in the lubricant cavity, and having an open second end located outside the lubricant cavity. A length of tubing connects a lube oil reservoir of the lube oil system to the conduit's second open end. The lube oil reservoir and the tubing provide a supply of lube oil to the lubricant cavity. The disclosed lube oil system includes a pressure inducing bell which has an open lower end. A passage connects the pressure inducing bell to the lube oil reservoir. The open lower end of the pressure inducing bell is located no higher than the lubricant cavity. Configured in this way, upon immersion of the open lower end of the pressure inducing bell in water, via the passage the lube oil system couples hydraulic pressure of the water in the pressure inducing bell to a column of air trapped atop the lube oil reservoir. The pressure of the air in the lube oil reservoir together with the pressure of lube oil in the reservoir is then coupled to the lubricant cavity via the tubing and the conduit. Coupling of hydraulic pressure of the water to the lubricant cavity pressurizes the lubricant cavity in opposition to hydraulic pressure of water around the sealed bearing that energizes infusion of water into the lubricant cavity regardless of depth.

An advantage is that the disclosed lube oil system may be used for all types of sealed bearing assemblies that become immersed in water such as those included in wheel spindle and hub assemblies of boat trailers, marine drives, amphibious or all terrain vehicles, and similar applications.

These and other features, objects, advantages and alternative applications will be understood or apparent to those of ordinary skill in the art from the following detailed description of the preferred embodiment as illustrated in the various drawing figures.

### BRIEF DESCRIPTION OF THE DRAWINGS

FIG. 1 is a perspective view depicting a portion of a boat trailer's frame including wheel spindle and hub assemblies that are coupled to the trailer's frame by axles and springs, and which also depicts a pressure compensated lube oil system in accordance with the present disclosure;

FIG. 2A is a partially sectioned perspective view of a wheel spindle and hub assembly in accordance with the present disclosure;

FIG. 2B is a cross-sectional elevational view of a wheel spindle and hub assembly in accordance with the present disclosure taken along the line 2B-2B in FIG. 2A; and

FIG. 3 is a functional diagram depicting a pressure compensated lube oil system in accordance with the present disclosure.

### DETAILED DESCRIPTION

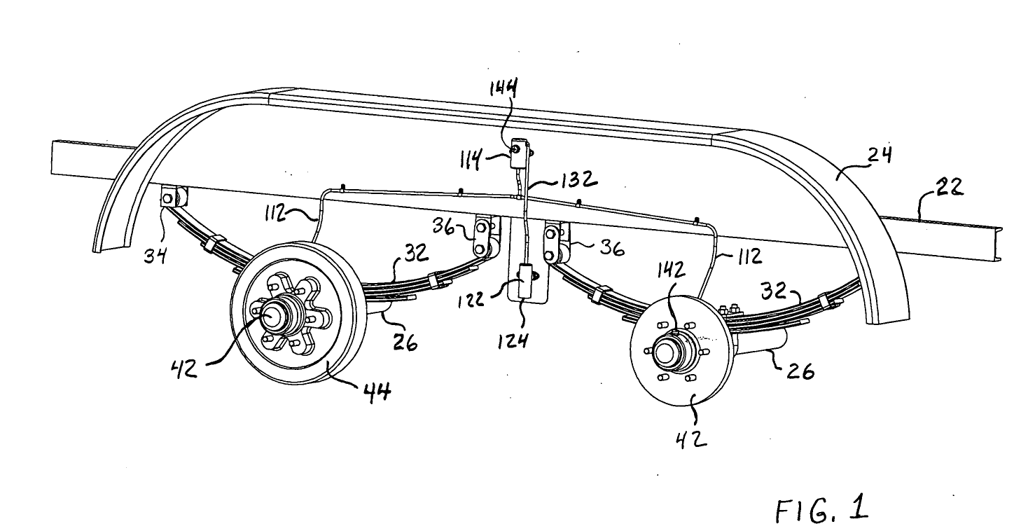

The perspective view of FIG. 1 illustrates a portion of a conventional boat trailer's frame 22 having a fender 24 secured thereto. FIG. 1 also illustrates ends of two (2) axles 26 that are respectively coupled to the frame 22 by a leaf spring 32. Each of the leaf springs 32 is secured to the frame 22 at one end by a hanger 34, only one of which appears in FIG. 1, and at another end by a movable shackle 36. Each end of the axles 26 respectively includes a wheel spindle and-hub assembly 42 only one (1) of which appears in FIG. 1. FIG. 1 depicts a brake drum 44 mounted on one of the wheel spindle and hub assemblies 42.

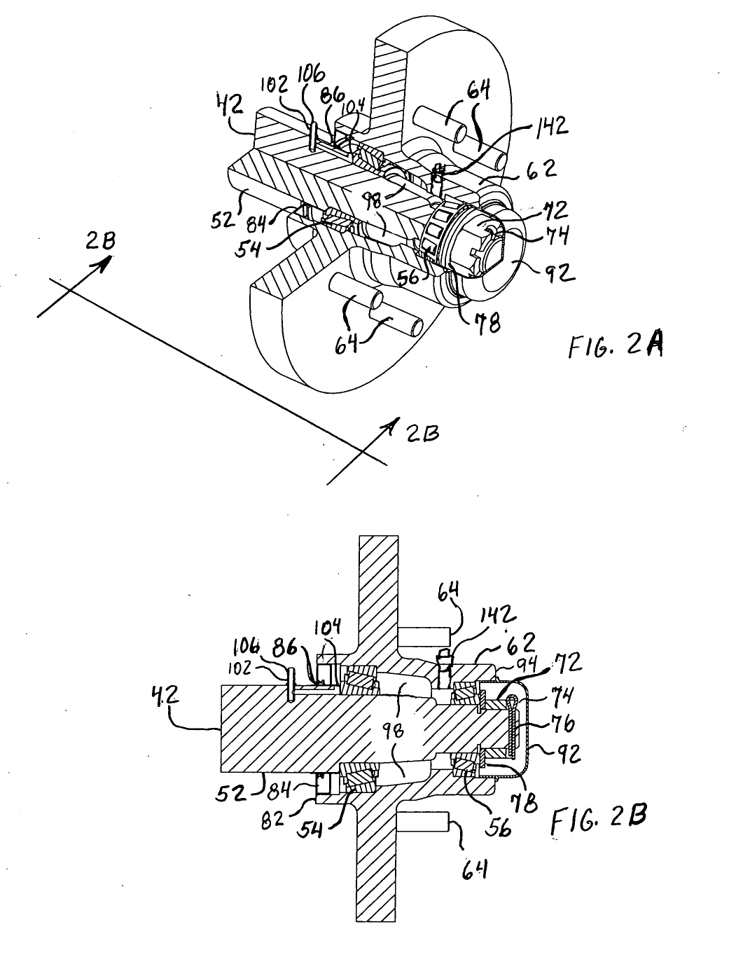

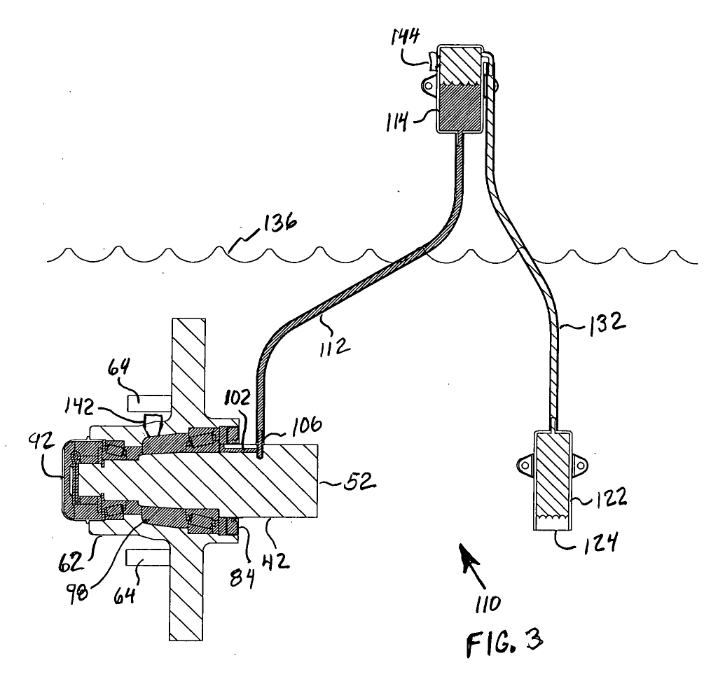

As better illustrated in FIGS. 2A, 2B and 3, each of the wheel spindle and hub assemblies 42 includes a spindle 52 that is fixedly attached at each end of the axle 26. An outwardly projecting end of the spindle 52 carries an inner wheel bearing 54 and a smaller diameter outer wheel bearing 56. The wheel bearings 54, 56 support a hub 62, which encircles the spindle 52, for rotation about the spindle 52. A number of studs 64 project outward from the hub 62 and pass through holes in the brake drum 44 for securing to the axle 26 a wheel rim carrying a tire, neither of which are illustrated in any of the FIGs.

A castellated lock nut 72, threaded onto an outermost end of the spindle 52, is locked there by a cotter pin 74 which passes through a hole 76 that pierces the outermost end of the spindle 52. The lock nut 72 presses a safety washer 78 against an outer surface of the outer wheel bearing 56. Not illustrated in any of the FIGs., a hole at the center of the safety washer 78 includes a tongue which mates with a keyway cut into the outermost end of the spindle 52. Mating of the tongue of the safety washer 78 with the keyway of the spindle 52 prevents rotation of the safety washer 78 about the spindle 52.

An inner side 82 of the spindle 52 carries a spring-loaded, double-lipped seal 84 which encircles the spindle 52. The seal 84 has an inner surface that mates with a stainless steel seal-ring 86 which is secured to and encircles the spindle 52. A dust cap 92 closes an outer end 94 of the spindle 52. Assembled in this way, the spindle 52, the seal 84, the dust cap 92 and the hub 62 establish a annularly-shaped lubricant cavity 98 encircling the spindle 52 inside of which the wheel bearings 54, 56 are sealed.

As described thus far, the wheel spindle and hub assembly 42 is conventional and widely used for boat trailers. The present disclosure departs from conventional wheel spindle and hub assemblies 42 by including a conduit 102 formed in the spindle 52. The conduit 102 has an open first end 104 located high within the lubricant cavity 98, and has an open second end 106 located outside the lubricant cavity 98.

A lube oil system in accordance with the present disclosure for the sealed wheel bearings 54, 56 of wheel spindle and hub assemblies 42 appears in FIG. 3, and is identified there by the general reference character 110. The lube oil system 110 includes a length of tubing 112 which connects at one end to the second end 106 of the conduit 102. An end of the tubing 112 distal from the second end 106 of the conduit 102 connects to a lower end of a lube oil reservoir 114. The lube oil reservoir 114, the tubing 112 and the conduit 102 supplies lube oil to the lubricant cavity 98 and to the wheel bearings 54, 56 sealed therein.

The lube oil system 110 also includes a pressure inducing bell 122 having an open lower end 124. The lower end 124 of the pressure inducing bell 122 is located no higher than the lubricant cavity 98 of the wheel spindle and hub assembly 42, and preferably at or slightly lower than the bottom of the seal 84. One end of a passage 132 connects high on the pressure inducing bell 122 and another end of the passage 132 connects high on the lube oil reservoir 114. Connected in this way, the passage 132 couples the pressure inducing bell 122 to the lube oil reservoir 114. Upon immersion of the open lower end 124 of the pressure inducing bell 122 below a surface 136 of water, hydraulic pressure of the water around the sealed wheel bearings 54, 56 is coupled:
1. from the pressure inducing bell 122 to the lube oil reservoir 114 via the passage 132; and
2. from the lube oil reservoir 114 to the lubricant cavity 98 via the tubing 112 and the conduit 102.
   In this way the lube oil system 110 pressurizes the lubricant cavity 98 in opposition to hydraulic pressure of water around the sealed wheel bearings 54, 56 that energizes infusion of water into the lubricant cavity 98.

To facilitate placing the lube oil system 110 in operation, the hub 62 preferably includes a plugged quick-fill aperture 142, and the lube oil reservoir 114 includes a plugged lube oil fill aperture 144 illustrated in FIG. 1. Removing a plug from the quick-fill aperture 142 that has previously oriented to the top of the hub 62 permits filling the lubricant cavity 98 and the lube oil system 110 with lube oil.

The lube oil system 110 described thus far may be easily retrofitted to conventional wheel spindle and hub assemblies 42 in the following way. First the dust cap 92, lock nut 72, safety washer 78, outer wheel bearing 56, inner wheel bearing 54 and hub 62 are removed from each of the spindles 52. The quick-fill aperture 142 is then drilled into each hub 62 and tapped to receive ⅛ inch National Pipe Thread (“NPT”) plug.

The seal-ring 86 is then removed from the spindle 52 and a hole drilled at or as near as practicable to the top of the spindle 52, and a short distance into the spindle 52 slightly inboard of where the seal-ring 86 was previously located. A path for the conduit 102 is then formed by grinding a narrow oil galley along the spindle 52 preferably parallel to a longitudinal axis of the spindle 52 from the hole just drilled therein to a shoulder on the spindle 52 which the inner wheel bearing 54 abuts in the assembled wheel spindle and hub assembly 42. A barb union, which provides the second end 106 of the conduit 102, is then pressed into the hole drilled into the spindle 52 after which a hole is drilled into the end of the barb union located within the spindle 52 by a drill that passes along the oil galley.

A greased metal rod is then inserted along the oil galley into the hole that has just been drilled into the end of the barb union. An epoxy cold-weld compound, preferably JB-Weld marketed by JB-Weld Company of Sulphur Springs, Tex., is then mixed and placed around the juncture between the barb union and the spindle 52, and into the oil galley over the greased rod to restore the exterior surface shape of the spindle 52 to that existing before grinding the oil galley. Masking tape placed over the epoxy helps in molding the cold-weld epoxy compound into the desired shape. When the epoxy cold-weld compound reaches a rubbery state, with a twisting motion the greased rod is withdrawn from the oil galley.

After the cold-weld epoxy compound cures fully, the masking tape is removed and any sharp edges of the epoxy are removed with a file. Some dressing and light sanding of the cured cold-weld epoxy compound may be required to restore the shape of the spindle 52 to accept the seal-ring 86. After restoring the surface shape of the spindle 52, rather than reinstalling the seal-ring 86 previously removed from the spindle 52 it is advisable to install a new seal-ring 86 onto the spindle 52 after coating the spindle 52 and the inside of the seal-ring 86 with silicone gasket sealer. A hole is then drilled through the seal-ring 86 immediately adjacent to the shoulder of the spindle 52 which the inner wheel bearing 54 abuts in the assembled wheel spindle and hub assembly 42, and over the oil galley previously ground into the spindle 52. This hole through the seal-ring 86 extends into the fully cured cold-weld epoxy compound thereby establishing the first end 104 for the conduit 102 at or as near as practicable to the top of the spindle 52. Formation of the conduit 102 is completed by verifying that the conduit 102 is open and clear from the barb union, i.e. the second end 106, to the hole drilled through the seal-ring 86, i.e. the first end 104.

After ensuring that the dust cap 92, lock nut 72, safety washer 78, outer wheel bearing 56, inner wheel bearing 54 and hub 62 are clean and free of any grease, metal chips, or any other contaminants, install a new seal 84 in the hub 62, lightly oil the wheel bearings 54, 56 and reassemble the wheel spindle and hub assembly 42. The reassembled wheel spindle and hub assembly 42 preferably uses a safety washer 78 having a larger outer diameter than that used for grease filled wheel spindle and hub assemblies 42.

Grease filled wheel spindle and hub assemblies 42 which are adapted for attempting to exclude water from the lubricant cavity 98 must use a smaller diameter safety washer 78 so grease can flow around the safety washer 78. Such wheel spindle and hub assemblies 42 permit forcing grease into the lubricant cavity 98 either through a grease fitting in the dust cap 92, or through grease fitting at the outermost end of the spindle 52 which connects to a longitudinal passage in the spindle 52 that opens between the inner wheel bearing 54 and the seal 84. With either of these lubrication systems, ensuring that the inner wheel bearing 54 is lubricated requires that grease flow around the safety washer 78. Grease forced past the safety washer 78 using either of these lubrication systems in lubricating the inner wheel bearing 54 also tends to force water out of the lubricant cavity 98. If the outer wheel bearing 56 fails, a smaller diameter safety washer 78 may not keep the hub 62 on the spindle 52 because it is too small to retain the hub 62. Because the disclosed system 110 uses lube oil rather than grease, the wheel spindle and hub assembly 42 can preferably use a larger, full size safety washer 78 which will retain the hub 62 on the spindle 52 even if the outer wheel bearing 56 should fail.

With all wheel spindle and hub assemblies 42 thus reassembled, the lube oil reservoir 114 is then fastened to the frame 22 twelve (12) to thirty-six (36) inches above the spindles 52. The tubing 112 is then connected from the bottom of the lube oil reservoir 114 to each of the second ends 106 of the conduits 102 now included in each of the spindles 52. The pressure inducing bell 122 is then fastened to the frame 22 so the lower end 124 is at or slightly lower than the bottom of the seal 84. The passage 132 is then connected between the top of the pressure inducing bell 122 and the top of the lube oil reservoir 114. Connecting the passage 132 between the pressure inducing bell 122 and the lube oil reservoir 114 completes assembly of the lube oil system 110, and readies it for filling.

Filling the lube oil system 110 employs a squeeze bottle or pump for forcing 90w lube oil through the quick-fill apertures 142 drilled into each of the hubs 62 until the lube oil reaches the lube oil reservoir 114. Immediately after filling a hub 62 with lube oil, the ⅛ inch NPT plug is installed into the quick-fill aperture 142. For trailers having several wheel spindle and hub assemblies 42 connected in parallel to a single lube oil reservoir 114, filling all but the last hub 62 stops when lube oil first appears in the lube oil reservoir 114. When filling the final hub 62, lube oil is forced into the hub 62 until the lube oil reservoir 114 is half full. Before installing wheels and tires on the wheel spindle and hub assemblies 42, rotate the hubs 62 by hand to assist in purging air from the system, and also allow the system to stand for about one-half hour. Add oil to the lube oil reservoir 114 via the fill aperture 144 as required to maintain the lube oil reservoir 114 half full.

After installing the wheels and tires, tow the trailer for a few short trips, one or two miles, periodically checking the oil level in the lube oil reservoir 114. It takes several thermal cycles to purge air remaining in the lubricant cavity 98, the conduit 102 and the tubing 112 from the lube oil system 110. As air is purged from the lube oil system 110, add oil as necessary to maintain the lube oil reservoir 114 one-quarter to one-third full. Before immersing the wheel spindle and hub assemblies 42 in water, the plug must be installed in the fill aperture 144 of the lube oil reservoir 114 to form a leak-free, air-tight seal. Proper operation of the lube oil system 110 requires that the lube oil reservoir 114 be air-tight and leak-free.

Although the present invention has been described in terms of the presently preferred embodiment, it is to be understood that such disclosure is purely illustrative and is not to be interpreted as limiting. For example, it is readily apparent that the lube oil reservoir 114 and the pressure inducing bell 122 may be made in one piece with the passage 132 preferably being enclosed entirely within the one-piece component. Also, the lower end 124 of the pressure inducing bell 122 need not have a diameter identical to that of the pressure inducing bell 122 itself. For example, the lower end of the pressure inducing bell 122 may be adapted to secure a length of tubing thereto with the distal end of the tubing, which now forms the lower end 124 of the pressure inducing bell 122, being located no higher than the lubricant cavity 98. Such a configuration for the pressure inducing bell 122 may prove advantageous for pressurizing a lubricant cavity of any type of machinery which becomes immersed in water. Consequently, without departing from the spirit and scope of the disclosure, various alterations, modifications, and/or alternative applications will, no doubt, be suggested to those skilled in the art after having read the preceding disclosure. Accordingly, it is intended that the following claims be interpreted as encompassing all alterations, modifications, or alternative applications as fall within the true spirit and scope of the disclosure including equivalents thereof. In effecting the preceding intent, the following claims shall:
1. not invoke paragraph 6 of 35 U.S.C. § 112 as it exists on the date of filing hereof unless the phrase “means for” appears expressly in the claim's text;
2. omit all elements, steps, or functions not expressly appearing therein unless the element, step or function is expressly described as “essential” or “critical;”
3. not be limited by any other aspect of the present disclosure which does not appear explicitly in the claim's text unless the element, step or function is expressly described as “essential” or “critical;” and
4. when including the transition word “comprises” or “comprising” or any variation thereof, encompass a non-exclusive inclusion, such that a claim which encompasses a process, method, article, or apparatus that comprises a list of steps or elements includes not only those steps or elements but may include other steps or elements not expressly or inherently included in the claim's text.

What is claimed is:

1. A pressure compensated lube oil system for a sealed bearing assembly that is conjoined with a lubricant cavity, the lube oil system comprising:
a conduit having an open first end located in the lubricant cavity, and having an open second end located outside the lubricant cavity;
a lube oil reservoir;
a length of tubing connected at a first end to the second end of the conduit and at a second end to the lube oil reservoir, the lube oil reservoir and the tubing being adapted for supplying lube oil to the lubricant cavity;
a pressure inducing bell having an open lower end, the open lower end of the pressure inducing bell being located no higher than the lubricant cavity; and
a passage connected between the pressure inducing bell and the lube oil reservoir for coupling the pressure inducing bell to the lube oil reservoir whereby-upon immersion of the open lower end of the pressure inducing bell in water hydraulic pressure of the water is coupled:
a) from the pressure inducing bell to the lube oil reservoir via the passage; and
b) from the lube oil reservoir to the lubricant cavity via the tubing and the conduit,
to thereby pressurize the lubricant cavity in opposition to hydraulic pressure of water around the sealed bearing assembly that energizes infusion of water into the lubricant cavity without using any moving parts.

2. The lube oil system of claim 1 wherein the lube oil reservoir is located above the lubricant cavity.

3. The lube oil system of claim 1 wherein the tubing connects low on the lube oil reservoir.

4. The lube oil system of claim 1 wherein the passage connects high on the lube oil reservoir.

5. The lube oil system of claim 1 wherein the passage connects high on the pressure inducing bell.

6. The lube oil system of claim 1 wherein the first end of the conduit is located high in the lubricant cavity.

7. The lube oil system of claim 1 wherein the sealed bearing assembly is included in a wheel spindle and hub assembly, and wherein at least a portion of the conduit passes through a spindle included in the wheel spindle and hub assembly.

8. The lube oil system of claim 7 wherein the lube oil reservoir is located above the lubricant cavity.

9. The lube oil system of claim 7 wherein the tubing connects low on the lube oil reservoir.

10. The lube oil system of claim 7 wherein the passage connects high on the lube oil reservoir.

11. The lube oil system of claim 7 wherein the passage connects high on the pressure inducing bell.

12. The lube oil system of claim 7 wherein the first end of the conduit is located high in the lubricant cavity.

13. A pressure compensated wheel spindle and hub assembly including a sealed bearing assembly that is conjoined with a lubricant cavity, the wheel spindle and hub assembly comprising:
a spindle;
at least one bearing mounted on the spindle;
a hub supported about the spindle by the at least one bearing thereby adapting the hub for rotation about the spindle;
at least one seal disposed between the hub and the spindle to thereby establish both the sealed bearing assembly and the lubricant cavity; and
a lube oil system that includes:
a) a conduit having an open first end located in the lubricant cavity, and having an open second end located outside the lubricant cavity;
b) a lube oil reservoir;
c) a length of tubing connected at a first end to the second end of the conduit and at a second end to the lube oil reservoir, the lube oil reservoir and the tubing being adapted for supplying lube oil to the lubricant cavity;
d) a pressure inducing bell having an open lower end, the open lower end of the pressure inducing bell being located no higher than the lubricant cavity; and
e) a passage connected between the pressure inducing bell and the lube oil reservoir for coupling the pressure inducing bell to the lube oil reservoir whereby upon immersion of the open lower end of the pressure inducing bell in water hydraulic pressure of the water is coupled:
i. from the pressure inducing bell to the lube oil reservoir via the passage; and
ii. from the lube oil reservoir to the lubricant cavity via the tubing and the conduit,
to thereby pressurize the lubricant cavity in opposition to hydraulic pressure of water around the sealed bearing assembly that energizes infusion of water into the lubricant cavity without using any moving parts.

14. The wheel spindle and hub assembly of claim 13 wherein the lube oil reservoir is located above the lubricant cavity.

15. The wheel spindle and hub assembly of claim 13 wherein the tubing connects low on the lube oil reservoir.

16. The wheel spindle and hub assembly of claim 13 wherein the passage connects high on the lube oil reservoir.

17. The wheel spindle and hub assembly of claim 13 wherein the passage connects high on the pressure inducing bell.

18. The wheel spindle and hub assembly of claim 13 wherein the first end of the conduit is located high in the lubricant cavity.

19. The wheel spindle and hub assembly of claim 13 wherein at least a portion of the conduit passes through the spindle of the wheel spindle and hub assembly.

20. The wheel spindle and hub assembly of claim 19 wherein the lube oil reservoir is located above the lubricant cavity.

21. The wheel spindle and hub assembly of claim 19 wherein the tubing connects low on the lube oil reservoir.

22. The wheel spindle and hub assembly of claim 19 wherein the passage connects high on the lube oil reservoir.

23. The wheel spindle and hub assembly of claim 19 wherein the passage connects high on the pressure inducing bell.

24. A trailer comprising:
a) a trailer frame;
b) at least two pressure compensated wheel spindle and hub assemblies coupled to the trailer frame, each wheel spindle and hub assembly having a sealed bearing assembly that is conjoined with a lubricant cavity and including:
i. a spindle;
ii. at least one bearing mounted on the spindle;
iii. a hub supported about the spindle by the at least one bearing thereby adapting the hub for rotation about the spindle; and
iv. at least one seal disposed between the hub and the spindle to thereby establish both the sealed bearing assembly and the lubricant cavity; and
c) a lube oil system for the wheel spindle and hub assemblies that includes:
i. a conduit having an open first end located in the lubricant cavity, and having an open second end located outside the lubricant cavity;
ii. a lube oil reservoir;
iii. a length of tubing connected at a first end to the second end of the conduit and at a second end to the lube oil reservoir, the lube oil reservoir and the tubing being adapted for supplying lube oil to the lubricant cavity;
iv. a pressure inducing bell having an open lower end, the open lower end of the pressure inducing bell being located no higher than the lubricant cavity; and
v. a passage connected between the pressure inducing bell and the lube oil reservoir for coupling the pressure inducing bell to the lube oil reservoir whereby upon immersion of the open lower end of the pressure inducing bell in water hydraulic pressure of the water is coupled:
1) from the pressure inducing bell to the lube oil reservoir via the passage; and
2) from the lube oil reservoir to the lubricant cavity via the tubing and the conduit,
to thereby pressurize the lubricant cavity in opposition to hydraulic pressure of water around the sealed bearing assembly that energizes infusion of water into the lubricant cavity without using any moving parts.

25. The trailer of claim 24 wherein the lube oil reservoir is located above the lubricant cavity.

26. The trailer of claim 24 wherein the tubing connects low on the lube oil reservoir.

27. The trailer of claim 24 wherein the passage connects high on the lube oil reservoir.

28. The trailer of claim 24 wherein the passage connects high on the pressure inducing bell.

29. The trailer of claim 24 wherein the first end of the conduit is located high in the lubricant cavity.

30. The trailer of claim 24 wherein at least a portion of the conduit passes through the spindle of the trailer.

31. The trailer of claim 30 wherein the lube oil reservoir is located above the lubricant cavity.

32. The trailer of claim 30 wherein the tubing connects low on the lube oil reservoir.

33. The trailer of claim 30 wherein the passage connects high on the lube oil reservoir.

34. The trailer of claim 30 wherein the passage connects high on the pressure inducing bell.
